(19) United States
(12) Patent Application Publication
(10) Pub. No.: US 2004/0179537 A1
(43) Pub. Date: Sep. 16, 2004

(54) Method and apparatus providing a mobile server function in a wireless communications device

(75) Inventors: Ralph Warren Boyd, Southwest Ranches, FL (US); Khosrow Raof, Davie, FL (US); Sergio Domenech, Pembroke Pines, FL (US); Dilip K. Doshi, Coral Springs, FL (US)

Correspondence Address: POSZ & BETHARDS, PLC, 11250 ROGER BACON DRIVE, SUITE 10, RESTON, VA, 20190, US

(73) Assignee: MOTOROLA, INC.

(21) Appl. No.: 10/385,583

(22) Filed: Mar. 11, 2003

(51) Int. Cl. H04L 12/28

(52) U.S. Cl. 370/395.54; 370/328; 370/356

(57) ABSTRACT

A mobile Internet server 200 and corresponding method 400 is arranged to function in a wireless communications device 103 where the server comprises a receiver 203 for receiving a first Internet Protocol (IP) message including a dynamic IP address; a controller 207 for parsing the IP message to obtain the dynamic IP address and associating the dynamic IP address with a server application 223; and a transmitter 205 for sending a second IP message using the dynamic IP address, the second IP message indicating availability of the mobile Internet server. The dynamic IP address is assigned 319 by a server service provider 300 in order to facilitate an IP session with the server.

### FIELD OF THE INVENTION

This invention relates in general to communication systems, and more specifically to a method and apparatus for providing a mobile server function or application in a wireless communications device.

### BACKGROUND OF THE INVENTION

Servers, such as Web or Internet servers in fixed locations are known. Wireless clients, resident and executing in wireless communications devices, are also available. For example, many cellular handsets allow a user to browse the Web. Browsing amounts to the user or specifically the handset or wireless communications device connecting to or accessing various servers to download and occasionally upload data or information files. These servers are in fixed locations and have static Internet Protocol (IP) addresses.

Issues, such as limited memory capacities and general access problems associated with mobility of wireless devices, have limited wireless devices to operating as client devices. A wireless communications device is mobile meaning it will not be in a static or fixed location. The mobility together with the finite IP address space means it is impractical to provision large numbers of mobile devices with static IP addresses. However a need exists for methods and apparatus that provide server functionality in a mobile device without using an intervening fixed server.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 depicts, in a simplified and representative form, a diagram of a communications system suitable for supporting mobile servers;

FIG. 2 depicts a block diagram of a mobile Internet server implemented in a wireless communications device;

FIG. 3 illustrates a block diagram of a wireless server service provider that facilitates sessions with mobile servers;

FIG. 4-FIG. 6 depicts relative timing diagrams for the interactions between a client, network elements, and the mobile Internet sever;

FIG. 7 shows a software architecture diagram for the mobile Internet server and the relationship of this architecture to its environment; and

FIG. 8-FIG. 10 show exemplary tables of filtering rules used with a secure firewall function of the mobile Internet server.

### DETAILED DESCRIPTION OF PREFERRED EMBODIMENT

In overview, the present disclosure concerns communications systems that provide service to communications units or more specifically user thereof operating therein. More particularly various inventive concepts and principles embodied in methods and apparatus for the implementation and provisioning of server functionality in a wireless communications unit s described. The communications systems of particular interest include but are not limited to those being planned or deployed such as various cellular systems or integrated digital enhanced networks from Motorola or 3^{rd} generation IP based systems or other systems using IP addressing for packet data services.

As further discussed below various inventive principles and combinations thereof are advantageously employed to provide dynamic Internet Protocol (IP) addresses to a wireless server operating within a wireless communications unit, such as a handset or messaging unit or the like, thus alleviating various problems associated with known systems while still facilitating setting up sessions with or between clients and wireless servers regardless of present locations for the wireless servers provided these principles or equivalents thereof are utilized.

The instant disclosure is provided to further explain in an enabling fashion the best modes of making and using various embodiments in accordance with the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms, if any, such as first and second, top and bottom, and the like are used solely to distinguish one from another entity or action without necessarily requiring or implying any actual such relationship or order between such entities or actions.

Much of the inventive functionality and many of the inventive principles are best implemented with or in software programs or instructions and integrated circuits (ICs) such as application specific ICs. It is expected that one of ordinary skill when guided by the concepts and principles disclosed herein will be readily capable of generating such software instructions and programs and ICs with minimal experimentation. Therefore, in the interest of brevity and minimization of any risk of obscuring the principles and concepts according to the present invention, further discussion of such software and ICs, if any, will be limited to the essentials with respect to the principles and concepts used by the preferred embodiments.

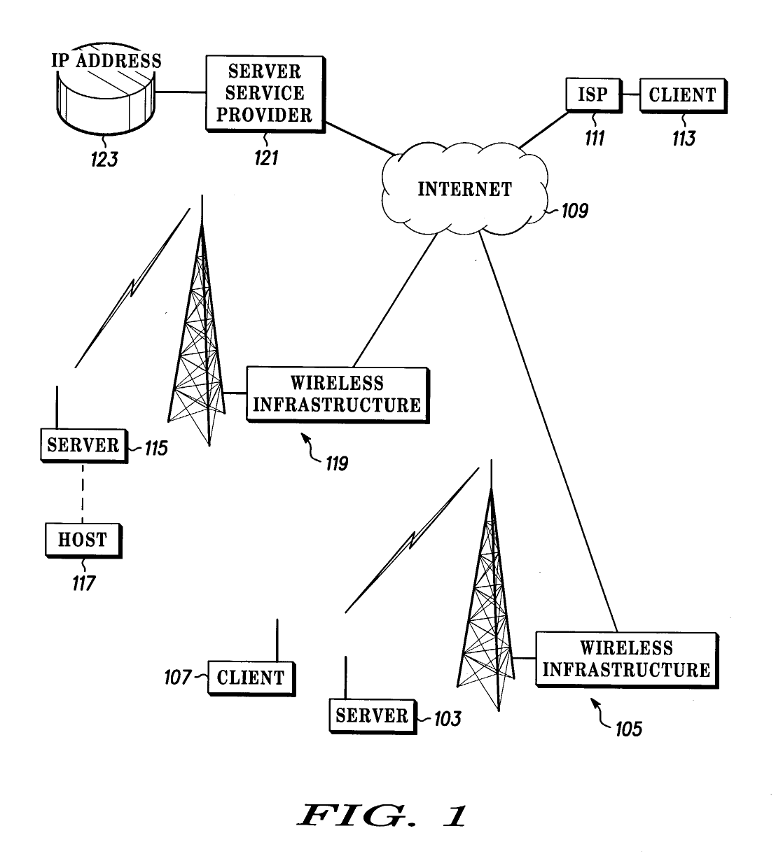

Referring to FIG. 1, a simplified and representative diagram of a communications system suitable for supporting mobile servers as depicted will be discussed and described. A mobile server or mobile Internet server 103 is shown operating, for example, in a wireless communications device such as a cellular handset, integrated digital enhanced network handset, mobile device, messaging device, personal digital assistant with wireless capability, or perhaps other device that is equipped with 802.11 or other wireless Local Area Network capability. The wireless Internet server is shown coupled to a wireless infrastructure 105, such as a radio access network. Generally the wireless infrastructure (alternately called fixed network equipment or FNE herein) is known and responsible for handling the air interface with the wireless communications device, thus mobile Internet server, as well as other wireless devices operating as clients, with one wireless client 107 depicted. The FNE is also responsible for handling mobility issues associated with the air interface and uses known techniques such as Home Location Registrars and Visitor Location Registrars whereby a home location registrar for a particular device knows the location of or the last visitors location registrar where the device may be located at all times.

The wireless infrastructure is coupled to one or more public networks such as the public switched telephone network and is depicted coupled to a public data network, specifically the Internet 109. The Internet is coupled to various routers, severs, Internet service providers (ISP) and the like with one ISP 111 providing service for one client 113 depicted. Another mobile Internet server 115 or wireless server optionally coupled to a host 117 with an air interface to a further FNE 119 is depicted. This may be indicative of a laptop personal computer with a wireless transceiver coupled to a radio access network or perhaps to an 802.11 access point within an expanded local area network. The wireless infrastructure 119 or FNE is also coupled to the Internet 109. In addition a server service provider 121 or SSP is shown coupled to the Internet 109 as well as an IP address pool 123. As will be discussed at length below the SSP 121 operates to assign an IP address from the IP address pool to a wireless server or mobile Internet server, such as server 103, 115 when a client, such as client 113 or 107 wishes to establish an IP link or connection or session with one of these servers. This IP address would be assigned on a dynamic basis and typically only for so long as the connection was in use or required.

Referring to FIG. 2, a block diagram of a mobile Internet server 200 implemented in a wireless communications device will be discussed and described. The various functional blocks depicted are generally known and used within many wireless communications devices. Thus our discussion will deal primarily with the modifications in function or results for these blocks in accordance with the inventive principles and concepts discussed and disclosed herein. As an overview the wireless communications device and thus mobile Internet server includes an antenna 201 for coupling a FNE to a receiver 203 and a transmitter 205. The receiver 203 and transmitter 205 are each coupled to and controlled by a controller 207 to support the air or wireless interface with the FNE. The controller is coupled to a user interface 209 including for example a keypad, display, and audio transducers and so forth. The controller may also be coupled to a host computer 211 or device.

The controller 207 includes a processor 213 comprised on one or more microprocessors or digital signal processors that are as known generally responsible for controlling the device and its various functional blocks as well as all signal processing functions that will vary according to the device particulars and air interface being supported. The processor 213 is coupled to a memory 215 comprised of RAM, ROM, EEPROM, and magnetic memory. The memory 215 includes an operating system as well as data and variables 217 that represent the object code that is executed by the processor in order to accomplish the control and processing responsibilities. Further included are the various software routines for setting up and managing IP sessions 219 including analyzing IP messages (parsing), handling connection issues and generating messages as generally known. Also is software for establishing a firewall 221 including routing tables and authorization procedures. Applications, including a server application 223, which is the software routines executed in order to support server functionality, is also included in memory 215. Additionally depicted is file or mass file storage 225 where files may be stored and accessed in accordance with typical server functionality. Other routines 227 are shown without being specifically identified, where such routines will be evident to one of ordinary skill, such as various control and user interface routines that are too numerous to mention and not further relevant.

In operation the mobile Internet server as noted is arranged to function in a wireless communications device. The mobile Internet server comprises the receiver 203 that operates for receiving a first message, preferably a first Internet Protocol (IP) message, that includes a dynamic IP address, where as we discuss below SSP 121 assigns the dynamic IP address. The controller is coupled to the receiver and operates to or for parsing the IP message to obtain the dynamic IP address and typically a port ID. The dynamic IP address and port ID is then bound to or associated with a server application. The transmitter coupled to and controlled by the controller then sends a second IP message using the dynamic IP address, where the second IP message was generated by the controller and indicates availability of the mobile Internet server for, for example, a session. The receiver usually receives the first IP message from a server service provider (SSP) 121 by way of the wireless infrastructure, where the SSP has obtained the dynamic IP address from the IP address pool and then assigned the dynamic IP address to the mobile Internet server.

The mobile Internet server or specifically the transmitter in one embodiment sends the second IP message to the SSP where it is forwarded to the client and in anther embodiment directly to the client using a client IP address obtained from the first IP message. In either event the mobile Internet server is arranged to and then operates to form an IP connection with the client and presumably exchange files or other data with the client. Thereafter the mobile Internet server operates to release the IP connection and the dynamic IP address. Tearing down or dropping or releasing the IP connection and IP address may be accomplished in various fashions. For example, the mobile Internet server can release the IP connection as a result of the receiver receiving a disconnect IP message from the client and, if so, the IP address is then released or unbound from the server application by the mobile Internet server and the transmitter then or concurrently sends an address release IP message to the SSP. Alternatively, the mobile Internet server may release the IP connection and unbind the dynamic IP address from the server application as a result of the receiver receiving a disconnect IP message from the SSP via the wireless infrastructure. The IP address is released by the SSP after a delay insuring the disconnect IP message has been received by the receiver.

Another issue for the mobile Internet server is security for files and data stored thereon. The controller 207 deals with this concern by implementing a secure firewall between the client and the server application or any other application that may be executing on the wireless communications device. Additional flexibility or functionality may be provided such that a client can reconfigure the secure firewall when so authorized. The secure firewall comprises routing tables to screen the exchanging the data. A client by providing a secure password may be authorized and allowed to temporarily modify the routing tables. Many of these concepts will be further discussed below with reference to various figures.

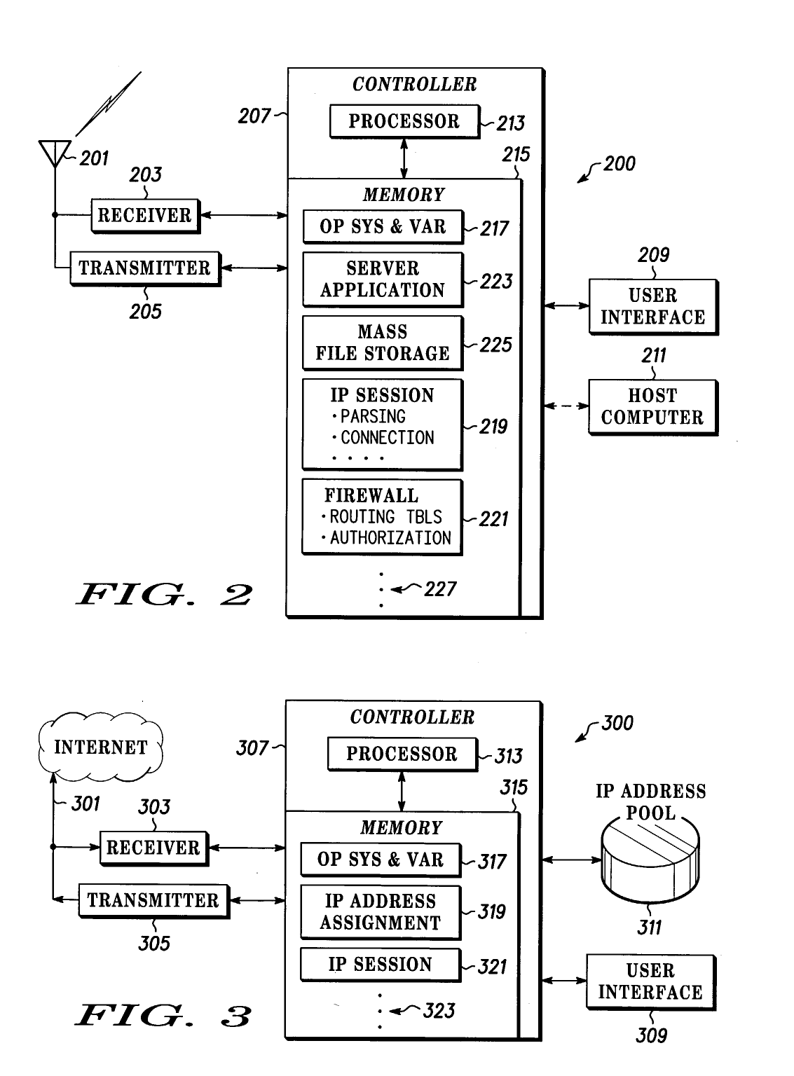

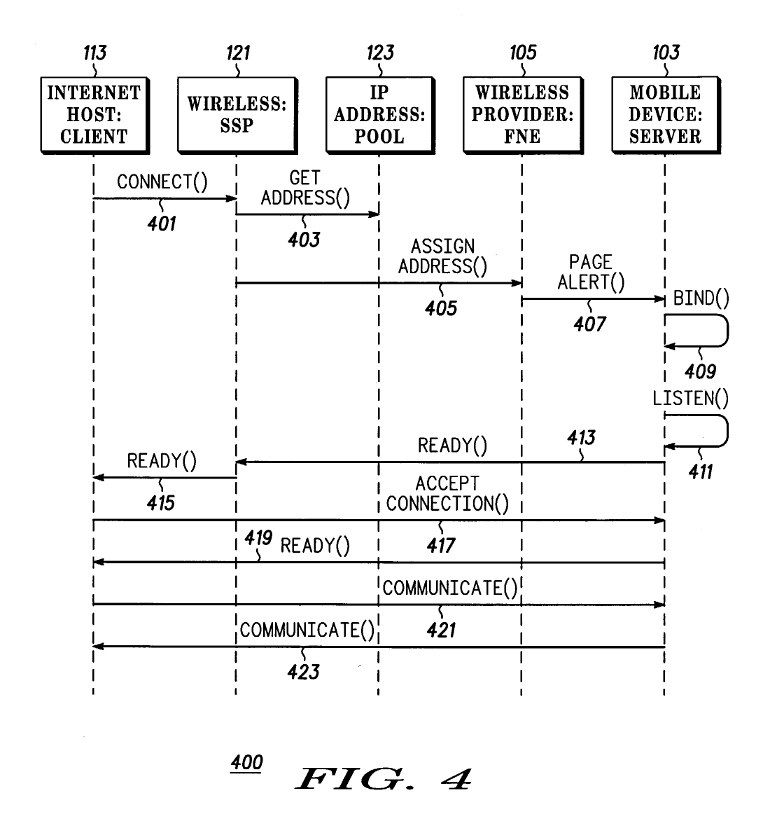

Referring to FIG. 3, a block diagram of a wireless server service provider 300 that facilitates sessions with mobile servers or communications between clients and mobile Internet servers will be discussed and described. In overview, the wireless server service provider or SSP is inter coupled with the Internet 301, World Wide Web, or other public packet data network and comprises a receiver 303 for receiving messages, preferably, an Internet Protocol (IP) message from a client where the IP message requests a connection to a mobile Internet server. The receiver is coupled to a controller 307 and the controller is operable for assigning a dynamic IP address for use by the mobile Internet server. The controller 307 is coupled to and controls a transmitter 305 that is used for forwarding by way of wireless infrastructure the IP message or substance of the message requesting the connection and the dynamic IP address to be used for this connection to the mobile Internet server. The receiver 303 and transmitter 305 are known devices such as Ethernet devices suitable for supporting the media and protocols used to interface to the network.

The controller 307 is further coupled to an IP address pool 311. As depicted, this pool may be co-located and may be stored on the SSP. Alternatively the address pool may be separately located and stored for example or a different server. The address pool may serve multiple server service providers and a multiplicity of wireless infrastructures and thus mobile Internet servers. The controller is further shown coupled to a user interface 309, including for example a known keyboard and monitor or display. The controller 307 includes a processor 313 comprised of one or more general purpose microprocessors. Due to the critical nature of the services provided by the SSP the processor 313 or constituent microprocessors and supporting functions such as power supplies and so on will often be configured in a high availability fault tolerant and redundant arrangement as is known.

The processor 313 is coupled to a memory 315 comprised of a combination of RAM, ROM, EEPROM, and magnetic memory that is used to store software routines as well as data and files that are useful for accomplishing the purposes of the SSP.

These routines include an operating system 317 in object code form that are the routines executed by the processor 313 to provide the SSP functionality together with requisite data and variables. Other routines include the IP address or dynamic IP address assignment 319 routines that facilitate selecting or obtaining an IP address and releasing such IP address from the IP address pool and insuring that this IP address is provided to the mobile Internet server as appropriate. Also IP session 321 routines are shown and these are used as is known to support various IP sessions. Additional routines 323 are depicted that are to numerous to mention and not here further relevant but that will be familiar to one of ordinary skill.

In operation as a further overview the wireless server service provider or SSP, specifically the receiver receives a further IP message from the mobile Internet server indicating that the mobile Internet server is ready to support the connection with the client and the SSP or specifically the transmitter as directed by the controller forwards the further IP message with the dynamic IP address to the client. The client and mobile Internet server may then establish and utilize an IP session. At some point the session will conclude and this may result in alternative processes. For example the receiver 303 may receive a disconnect IP message from the client and then the transmitter 305, responsive to the controller 307, forwards a message to the mobile Internet server directing that the connection be dropped and the dynamic address released. Thereafter the and responsive thereto the receiver will receive a message indicating that the dynamic IP address has been released or unbound by the mobile Internet server and responsive thereto the SSP or specifically controller releases the dynamic IP address. Alternatively the wireless server service provider or the receiver receives a message from the mobile Internet server indicating that the dynamic IP address should be released and responsive thereto the controller releases the dynamic IP address. In summary as briefly explained the wireless server service provider or specifically the controller assigns the dynamic IP address for use by the mobile Internet server from a pool of dynamic IP addresses that includes a limited number of dynamic IP addresses that may be reused to support connections between clients and mobile servers.

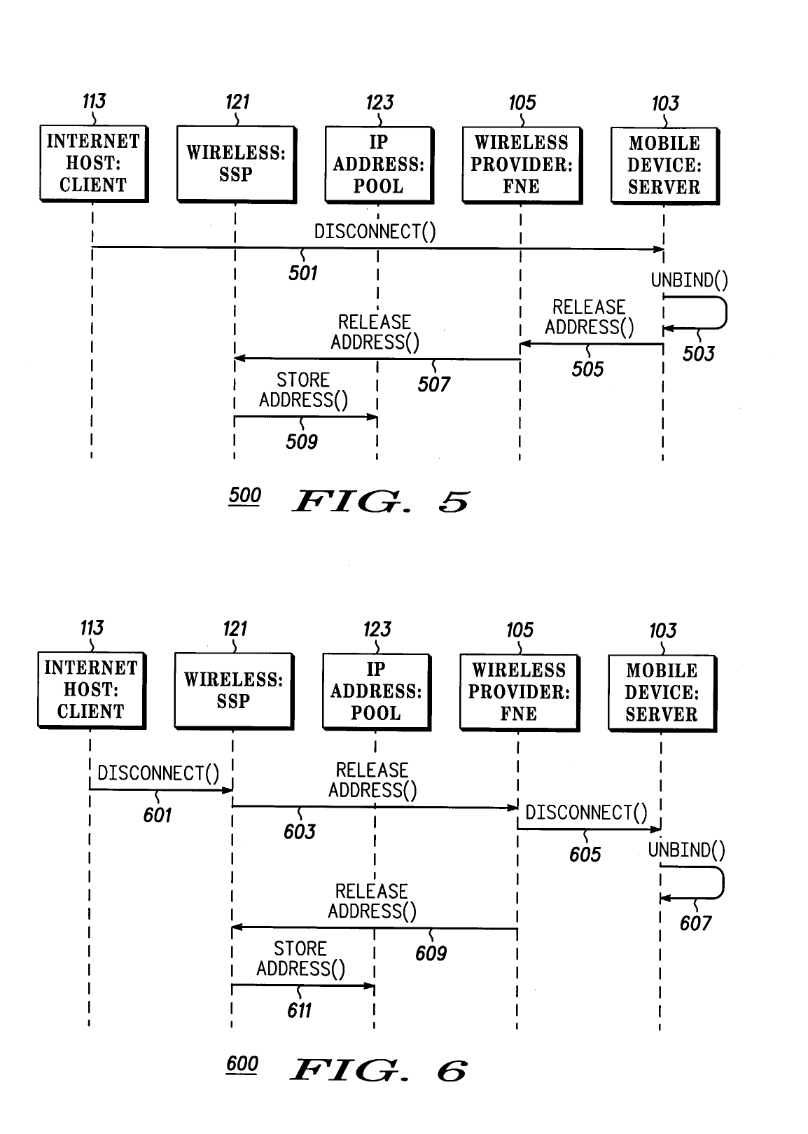

Referring to FIG. 4-FIG. 6, relative timing diagrams for the interactions between a client, various network elements including the SSP, and the mobile Internet sever will be discussed and described. FIG. 4 shows procedures and interactions for setting up a session with a dynamic IP address for a mobile Internet server while FIG. 5 and FIG. 6 show alternative approaches for tearing down or discontinuing the session. In each of FIG. 4-6 across the top are shown the client 113, the wireless server service provider or SSP 121, the IP address pool 123, the wireless infrastructure or FNE 105, and the mobile Internet server 103. Time increases or passes as we move from top to bottom along or down the vertical axis.

FIG. 4 depicts a method 400 of providing a mobile server function, preferably within a wireless communications device, to a client. The method begins with the client or Internet host requesting a connection 401 with a mobile server where this message is preferably an IP message directed to the SSP 121. The SSP 121 in turn requests of or gets an IP address 403 or dynamic IP address from the IP address pool 123. Once the dynamic IP address has been obtained, a message with or assigning the dynamic IP address 405 to the mobile Internet server for the requested session is forwarded to the wireless infrastructure 105 or wireless service provider or FNE. The FNE, using known air interface and mobility management techniques will locate the wireless communications device acting as the target mobile Internet server and forward this message as or as a part of a page alert 407 or successive messages to the mobile server 103. The mobile server receives these messages including, preferably, a first Internet Protocol (IP) message, requesting the IP connection between the client and the mobile server function, where the message includes the IP address or dynamic IP address that has been temporarily assigned for this IP connection.

This message as received is processed, including parsing the IP message to obtain the IP address. The IP address and typically corresponding port number are associated with or bound with a server application 409. The mobile Internet server enters a wait or listen for connection mode 411 until the mobile Internet server forwards or sends an IP message 413 using the IP address that has been temporarily assigned as the origination address to the SSP. This IP message is intended ultimately for the client and indicates availability of the mobile server function or that the server function is ready to establish a link. The SSP receives the IP message and thus knows the IP address will be used for the session and forwards 415 the message to the client. The client accepts 417 or acknowledges the availability of the server by returning a message to the mobile Internet server. This message is acknowledged 419 thus forming an IP connection or session with the client and communications packets are exchanged 421, 423. As we will discuss further below receiving IP messages from the client will include processing these messages through or with a secure firewall application to insure such IP message are suitable for routing to the server application. When the client is so authorized the client may be allowed to reconfigure the secure firewall. Generally the reconfiguring the secure firewall comprises obtaining a secure password from the client and then allowing the client to temporarily modifying routing tables that are used to screen the exchanging the data.

Thus receiving the initial IP message includes receiving the message from the server service provider (SSP) by way of a wireless infrastructure, where the SSP has assigned a dynamic IP address. As discussed above the IP message indicating availability of the mobile Internet server may be sent to the SSP, however alternatively this IP message can be sent directly to the client using a client address when provided with the initial IP message. In the first case where the response IP message goes to the SSP, the SSP if a sufficient amount of time lapses before hearing back from the mobile Internet server may assume that the mobile server was not contacted and thus release the IP address for other uses. In the latter case it may be prudent to inform the SSP that the session is being conducted so that the SSP can release the dynamic IP address in the event the mobile Internet server does not respond and thus the IP address will not be tied up for to long. The mobile server or the FNE under appropriate circumstances could generate this message informing the SSP.

Referring to FIG. 5, one method 500 of disconnecting or releasing the IP connection is discussed and described. In this method the IP connection is released as a result of receiving at the mobile server a disconnect IP message from the client and the IP address is released back to the IP address pool as a result of sending an address release IP message to the SSP. In more detail the client 113 sends a disconnect message 501 or request to the mobile Internet server 103. Responsive thereto the mobile server unbinds or disassociates the temporary or dynamic IP address 503 and corresponding port ID or number from the server application. Then a release IP address message is forwarded to the FNE 505 and from there the SSP is sent the release IP address message 507. The IP address is released 509 and returned or retagged in the IP address pool as being available for another session with the same or another mobile Internet server.

Referring to FIG. 6, another method 600 of disconnecting or releasing the IP connection is discussed and described. In this method the IP connection is released as a result of receiving at the mobile server a disconnect IP message from the SSP by way of the wireless infrastructure. The IP address is released by the SSP after the disconnect IP message has been forwarded by the FNE and thus received by the mobile server as preferably indicated by a message to the SSP from the FNE. In more detail, a disconnect message 601 is sent from the client to the SSP. The SSP, responsive thereto, forwards a release address message 603 to the FNE and this disconnect or release IP address message is the sent 605 by the FNE to the mobile server. Responsive thereto, the mobile server unbinds or disassociates the temporary or dynamic IP address 607 and corresponding port ID or number from the server application. The FNE after a sufficient lapse of time and possibly ordinary air interface messages acknowledging the message 605 sends a release IP address message 609 back to the SSP. The IP or dynamic IP address is released 611 and returned or retagged in the IP address pool as being available for another session with the same or another mobile Internet server.

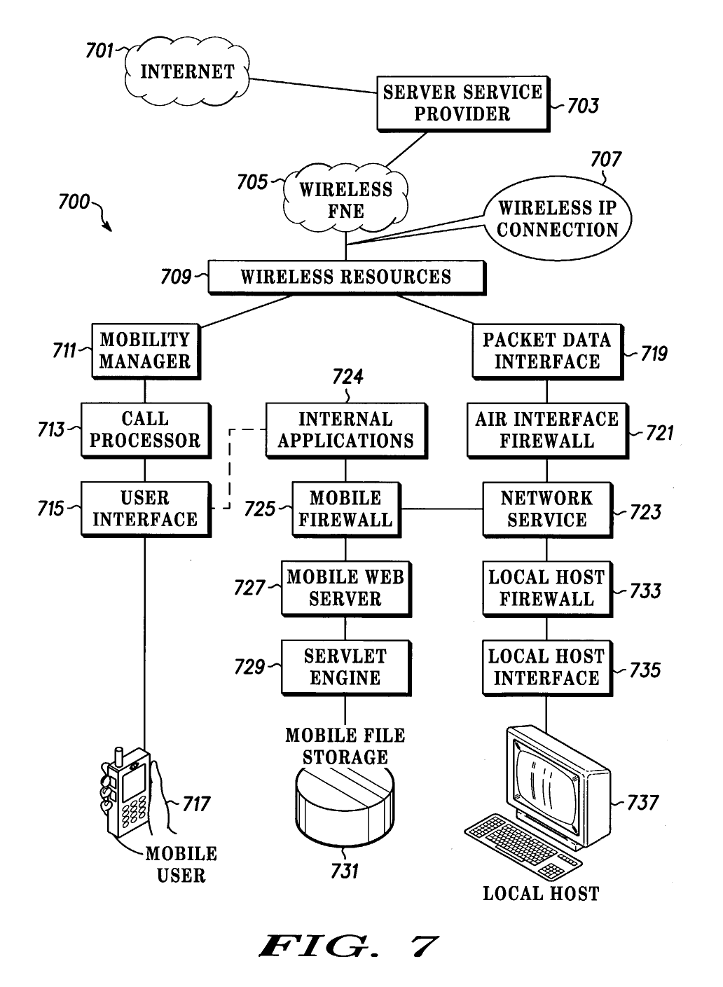

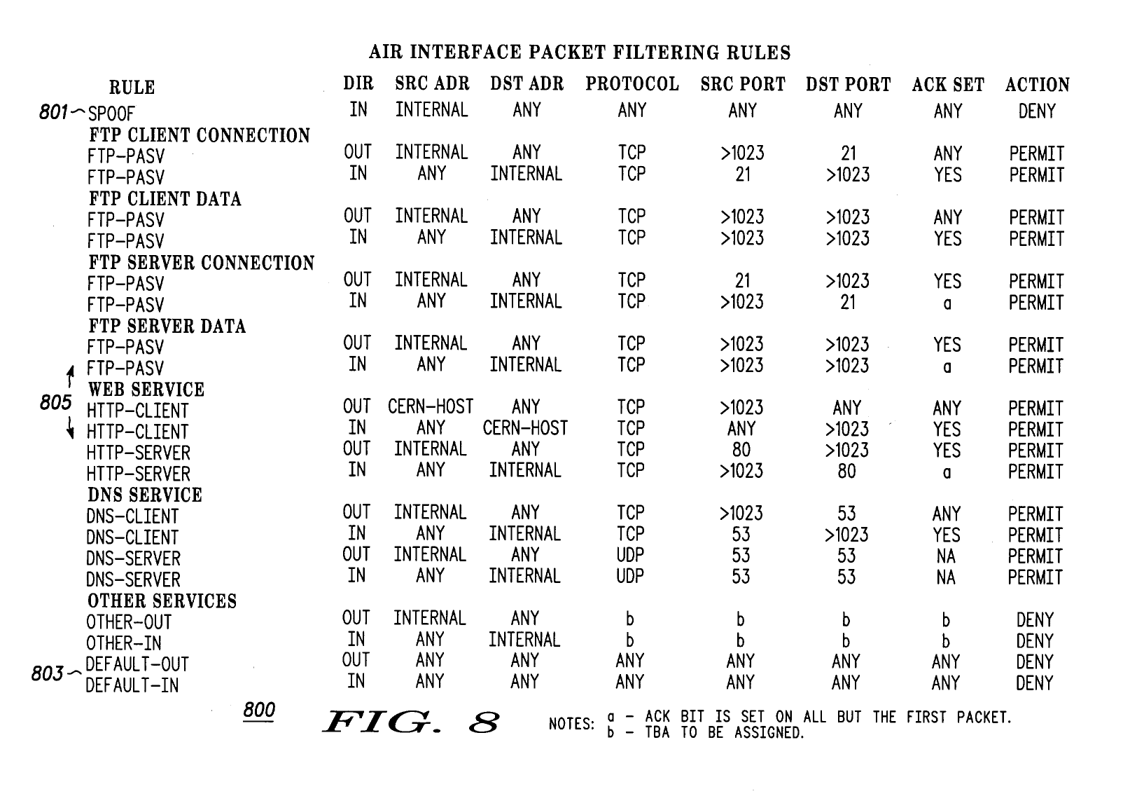

Referring to FIG. 7, a software architecture diagram 700 for the mobile Internet server as it relates to various other entities will be discussed and described. FIG. 7 depicts the Internet 701 corresponding to 109 in FIG. 1 and packet data traffic originating or destined thereto often passes through the server service provider 703, corresponding to the 121 in FIG. 1. The SSP 703 interfaces to the wireless infrastructure or radio access network or FNE 705, corresponding to 105 in FIG. 1. The FNE 705 supports a wireless IP connection 707 with the mobile Internet server or wireless resources 709. The wireless resources support to distinct functions with one being the interface and interactions between a user 717 of the wireless communications device and the Internet, etc. This branch includes a mobility manager 711 that is responsible for keeping in touch with the FNE with registration and the like. This interfaces to a call processor that handles signal processing and the like that will be air interface dependent and is generally known once an air interface is selected or determined. This provides an interface to the user interface 715, which handles interaction with the user 717.

The other branch from the wireless resources is the packet data branch and includes a packet data interface 719 that is responsible for receiving and analyzing inbound messages and forming and forwarding outbound messages in accordance with signaling conventions for the particular packet data interface being utilized. This is the air interface entry point for the mobile server functionality. Inbound messages after being processed are passed to and processed by an air interface firewall 721. Similarly messages that are outbound to the packet data interface 719 are likewise processed through the air interface firewall. Essentially the firewall filters message attributes through routing tables that determine whether the message will be allowed to pass the firewall and thus forwarded to the network service function 723, if inbound or packet data interface 719, if outbound or otherwise responded to. These routing tables have filtering attributes and the like that may vary with the direction of message flow as will be discussed further below. The network service block 723 operates in many respects as a router and determines where messages from one interface should go. For example if a message from the air interface firewall should go to the mobile firewall 725 it passes this inbound messages to the mobile firewall where it is processed and if appropriate allowed to pass to mobile server application 727.

The server application 727 operates to parse and route or pass inbound messages to the servlet engine 729. The servlet engine 729 manages storing new files on the mobile file storage system 731 and retrieving any files that may be requested by a client. The server application 727 and servlet engine 729 provide additional screening to insure that only proper access is allowed to the file storage system 731 and that information retrieved from the storage system 731 is presented to a client in a proper form, such as a web page form. Files that are retrieved or other messages generated by the mobile server application are returned to and processed by the mobile firewall and from there passed to the network service function 723 where they are routed to and processed by the air interface firewall. If they are satisfactory they are allowed to pass to the packet data interface 719, where they are delivered to the client via the balance of the network elements.

Another access point to the server application is provided for other mobile applications 724 resident within the mobile device. These applications may be launched by the user of the device or by an external client if properly authorized. These applications, specifically messages generated thereby are passed to and processed by the mobile firewall 725 and if satisfactory allowed to pass to the mobile server application 727 and so on as discussed above. Outbound messages from the server application are again processed by the mobile firewall and if satisfactory passed to the mobile applications. Another optional access point allows a local host 733 (see FIG. 1 117) to have access to the mobile server. In this case messages and the like from or to the local host pass through a local host interface 735 that is any of a multiplicity of known interfaces such as a USB or serial bus interface or the like. The local host interface 735 is coupled to a local host firewall with its routing tables that operates as noted above to pass messages when appropriate. These messages are passed to or from the network service function 723 and from there to the mobile firewall and server application as noted above.

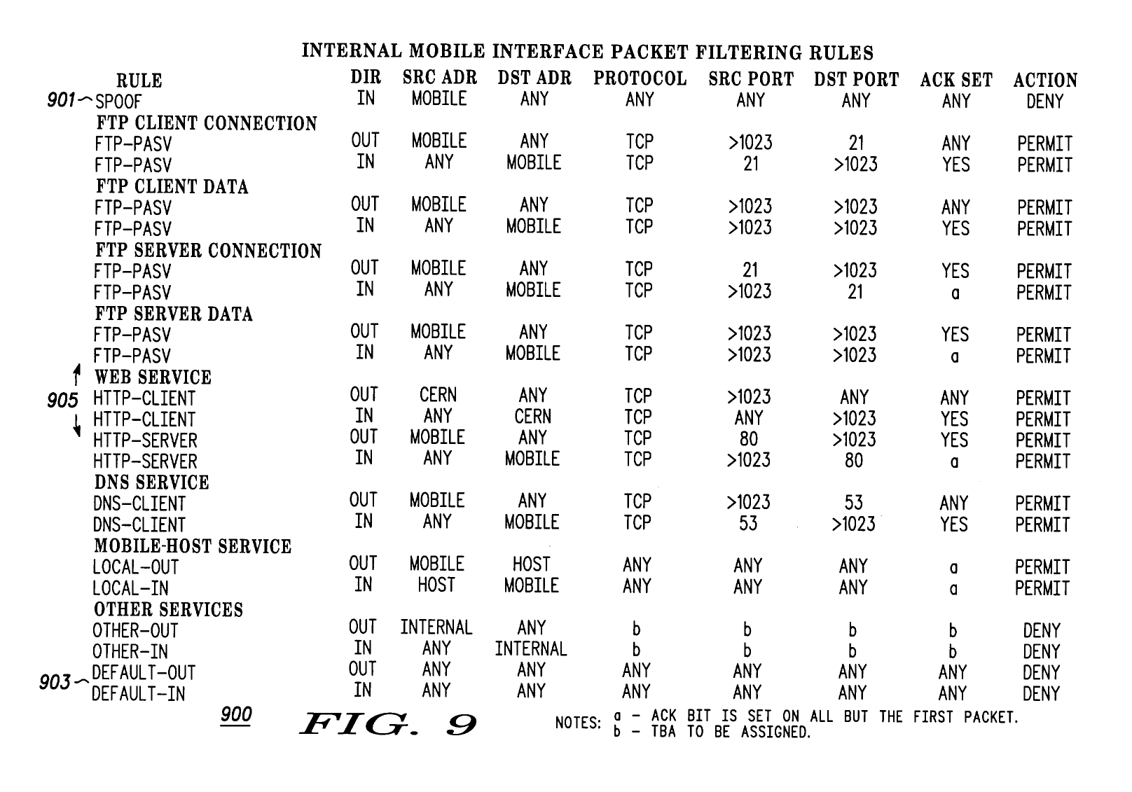

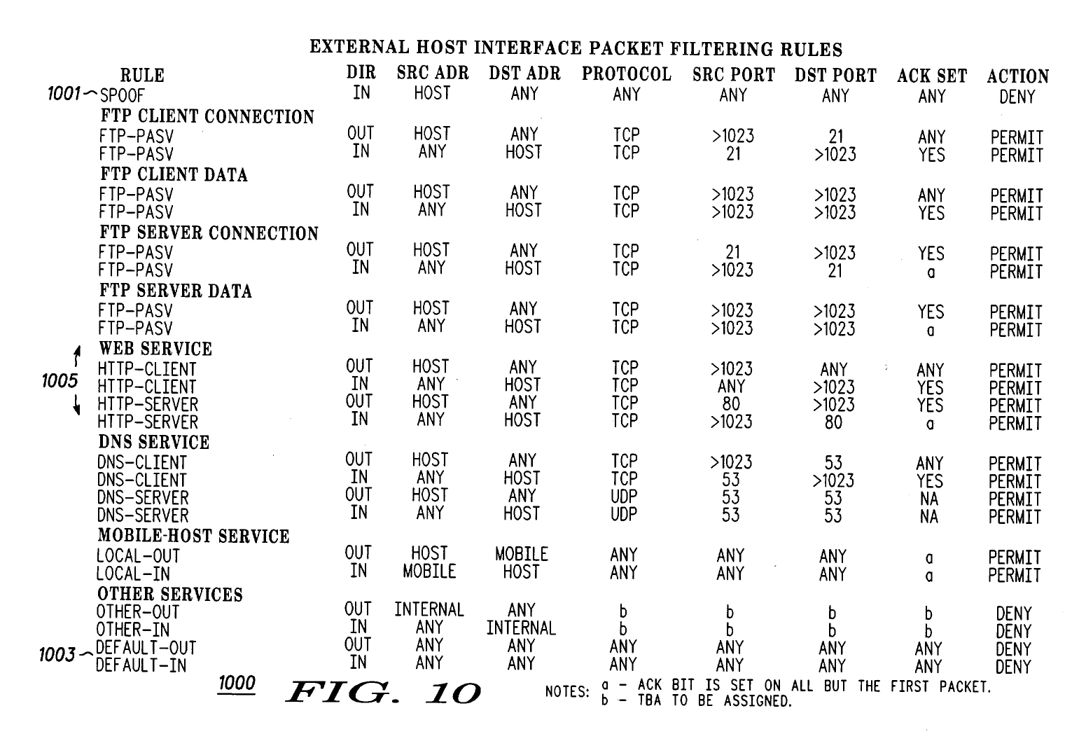

Referring to FIG. 8-FIG. 10, exemplary tables of filtering rules used with the secure firewall function of the mobile Internet server will be discussed and described. FIG. 8 depicts an exemplary table 800 for the air interface firewall 721. FIG. 9 shows an exemplary table 900 for the mobile firewall 725 and FIG. 10 shows a table 1000 for the local host firewall 735. Each of the firewall routines parse messages or packets that are presented, specifically the packet IP and TCP headers for example, to identify or obtain directional information (In or Out), source and destination IP addresses, service protocol represented or carried by the packet, TCP source and destination ports, and the acknowledge bit in the TCP header. The default rule or policy for these firewalls is to deny service or not allow a data packet to pass the firewall. The exceptions to the default rule are packets that satisfy all of the filtering criteria for one or more or the filtering rules in which case the packet will be allowed to pass. If a rule is not satisfied the packet is discarded. For denial of service attacks, such as a barrage of “ping” packets presented to the air interface firewall, the hostile packets will be silently discarded. Other messages or packets failing to qualify for passage by a firewall may be acknowledged by Internet Control Message Protocol (ICMP) response messages thereby informing the originator or sender of the reason for refusal of service. The rules in each table are applied to a packet beginning with the first or top most rule and ending with the last or bottom rule.

Each of the tables in FIG. 8-FIG. 10 begins with a spoofing rule 801, 901, 1001 that blocks attacks from the outside of the respective interface by an IP packet masquerading as an internal IP address. For example, the air interface table 800 blocks packets using rule 801 that are inbound with an internal source address. Similarly the mobile table 900 blocks packets using rule 901 that are inbound with a mobile source address and local host table 1000 blocks packets using rule 1001 that are inbound and have a host source address. Furthermore each of the tables includes as a last entry and thus last applied to a packet seeking to cross over the respective firewall a rule that blocks passage of any packet that has not been qualified by any of the previous rules. For example table 800, 900, and 1000 have default out and in rules 803, 903, 1003, respectively, that block packets that have not otherwise been qualified for passage through the, respective, firewall. In keeping with the top to bottom application of rules these spoofing and default entries are always placed first and last in the routing tables associated with the firewalls. Other policies, rather than top to bottom, of applying the rules would result in different and corresponding placement of the spoofing and default entries or rules.

The table entries between the spoofing and the default entries are used for standard and other services or user defined client/sever services. The tables show support for Passive mode FTP, HTTP, and DNS services. Other service protocols can be included in one or more of the table in the mobile firewall. The only requirement is that these services must be statically listed into the appropriate table between the spoofing and other services entries. This region between the spoofing and other services is for client/server applications that are permanently installed on the mobile device. The other services section may be used as a dynamic area in the firewall rules table for client/server applications that may be downloaded onto the mobile device. The default rule for such uninstalled services is the normal default rule, namely to block all outbound and inbound packets containing any internal source or destination IP addresses respectively.

However, the other services area of the table may be advantageously used to add or temporarily add additional applications or functionality, such as peer to peer applications, to the mobile device or mobile server, provided proper authentication and authorization procedures are adopted and utilized. Before an application can gain access through the firewall(s) it must place entries or proper rules into the appropriate packet routing or filtering table(s) for the respective interface(s). To do this without intervention by a user, an application can make a secure connection to an application program interface (API) within the firewall and use this connection to fill or populate the filtering table with appropriate entries needed for access through the firewall.

One approach is to send an encrypted message to the firewall from the application, where the encrypted message contains an identifier or password that is decrypted by the firewall software and used to either grant or deny access to the firewall's other API functions. If or when the firewall grants access, the application can then send a message with information to fill or populate the table entries in the specified router or filtering tables. The Firewall can also implement other rules according to other security policies, such as allow or deny specific protocols, source IP addresses, or ports. If the policies or rules are satisfied by the information from the application the firewall software will update the router or filtering tables with the new entries as requested. After this the application can send message requests to the firewall to route IP packets. The firewall verifies the source or destination addresses, ports, and protocol with the table entries and when confirmed as valid or legitimate, routes the packets to the destination as requested. If the packet data cannot be confirmed, the packet is discarded. The firewall validates all inbound and outbound packets in the same manner as the statically configured rules before permitting any packets to cross the firewall.

Once the new or added client or server application is finished with a session and before it is terminated, the application should send a message to the firewall to remove the additional entries from the router or filter table. The firewall then replaces the table entries with the default values once again denying access through the firewall. It may be appropriate to have the removal message password protected to avoid inappropriate removal. Furthermore, the additional entries should have an expiration life or time to live attribute whereby each entry in the dynamic or other services portion of the table is replaced with a predetermined default value upon expiration of the time to live. This protects against an application failing to shut down appropriately and thus failing to request that its particular entries be replaced. This will avoid an inadvertent hole in the firewall. When these connections are relying on a wireless connection this may be particularly important given the variability of these wireless connections due to mobility and other factors.

Thus the wireless communications device or mobile server executing thereon may be reconfigured or additional functionality may be added without user intervention. This is accomplished in a secure manner provided an external client or server application is able to authenticate and be authorized to access APIs associated with a firewall and use this access to temporarily provide new entries that are used to modify filtering or routing tables within the firewall. Once the need for these new entries has lapsed or timed out the original table entries are restored.

The processes, apparatus, and systems, discussed above, and the inventive principles thereof are intended to and will alleviate problems caused by prior art approaches where a mobile server was not available. Using these principles and concepts to provide mobile servers that may be configured as required will facilitate collection of information and files that may be geographically dependent or where the desired information may vary over time thus requiring server modifications. One of the principles used is assigning dynamic or temporary Internet Protocol addresses to the mobile server thus alleviating the need for large IP address spaces that large numbers of mobile servers would otherwise necessitate.

Various embodiments of methods, systems, and apparatus for providing secure mobile servers with dynamic IP addresses that may be reconfigured without user intervention so as to facilitate and provide for new or modified functionality in an efficient and timely manner have been discussed and described. It is expected that these embodiments or others in accordance with the present invention will have application to many wide area wireless networks that provide for mobility of their user or subscriber devices or units as well as wireless local area networks that are coupled to fixed WANS such as the PSTN or Internet. The disclosure extends to the constituent elements or equipment comprising such systems and specifically the methods employed thereby and therein. Using the inventive principles and concepts disclosed herein advantageously allows or provides for low latency and low network overhead access to contact information for mobile servers operating in wireless communications units or devices and procedures for maintaining such information which will be beneficial to users and providers a like.

This disclosure is intended to explain how to fashion and use various embodiments in accordance with the invention rather than to limit the true, intended, and fair scope and spirit thereof The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

What is claimed is:

1. A mobile Internet server arranged to function in a wireless communications device, the mobile Internet server comprising:
a receiver for receiving a first Internet Protocol (IP) message including a dynamic IP address;
a controller, coupled to the receiver, for parsing the IP message to obtain the dynamic IP address and associating the dynamic IP address with a server application; and
a transmitter, coupled to the controller, for sending a second IP message using the dynamic IP address, the second IP message indicating availability of the mobile Internet server.

2. The mobile Internet server of claim 1 wherein the receiver receives the first IP message from a server service provider (SSP) by way of a wireless infrastructure, the SSP having assigned the dynamic IP address.

3. The mobile Internet server of claim 2 wherein the transmitter sends the second IP message to one of the SSP and a client having a client IP address.

4. The mobile Internet server of claim 3 further comprising forming an IP connection with the client and exchanging data with the client.

5. The mobile Internet server of claim 4, wherein the IP connection and the dynamic IP address are each released.

6. The mobile Internet server of claim 5 wherein the IP connection is released as a result of the receiver receiving a disconnect IP message from the client and the IP address is released as a result of the transmitter sending an address release IP message to the SSP.

7. The mobile Internet server of claim 5 wherein the IP connection is released as a result of the receiver receiving a disconnect IP message from the SSP by way of the wireless infrastructure and the IP address is released by the SSP after the disconnect IP message has been received by the receiver.

8. The mobile Internet server of claim 4 wherein the controller implements a secure firewall between the client and the server application.

9. The mobile Internet server of claim 8 wherein the client can reconfigure the secure firewall when the client is so authorized.

10. The mobile Internet server of claim 9 wherein the secure firewall comprises routing tables to screen the exchanging the data and providing a secure password will authorize the client to temporarily modify the routing tables.

11. A wireless server service provider arranged and constructed to facilitate communications between clients and mobile Internet servers, the wireless server service provider comprising:
a receiver for receiving an Internet Protocol (IP) message from a client, the IP message requesting a connection to a mobile Internet server;
a controller, coupled to the receiver, for assigning a dynamic IP address for use by the mobile Internet server; and
a transmitter, coupled to the controller, for forwarding by way of wireless infrastructure the IP message requesting the connection and the dynamic IP address to the mobile Internet server.

12. The wireless server service provider of claim 11 wherein the receiver receives a further IP message from the mobile Internet server indicating that the mobile Internet server is ready to support the connection with the client and wherein the transmitter forwards the further IP message with the dynamic IP address to the client.

13. The wireless server service provider of claim 12 wherein the receiver receives a disconnect IP message from the client and the transmitter forwards a message to the mobile Internet server directing that the connection be dropped and the dynamic address released and responsive thereto the receiver receives a message indicating that the dynamic IP address has been released and responsive thereto the controller releases the dynamic IP address.

14. The wireless server service provider of claim 12 wherein the receiver receives a message from the mobile Internet server indicating that the dynamic IP address should be released and responsive thereto the controller releases the dynamic IP address.

15. The wireless server service provider of claim 11 wherein the controller assigns the dynamic IP address for use by the mobile Internet server from a pool of dynamic IP addresses that includes a limited number of dynamic IP addresses that may be reused to support connections between clients and mobile servers.

16. A method of providing a mobile server function in a wireless communications device, the method comprising:
receiving a first message requesting an Internet Protocol (IP) connection between a client and the mobile server function, the message including an IP address that has been temporarily assigned for the IP connection;
parsing the first message to obtain the IP address and associating the IP address with a server application; and
sending a second IP message using the IP address, the second IP message intended for the client and indicating availability of the mobile server function.

17. The method of claim 16 wherein the receiving comprises receiving a first IP message from a server service provider (SSP) by way of a wireless infrastructure, the SSP having assigned the dynamic IP address.

18. The method of claim 17 wherein the sending the second IP message further comprises sending the second IP message to one of the SSP and the client having a client IP address.

19. The method of claim 18 further comprising forming an IP connection with the client and exchanging data with the client wherein the exchanging data further comprises processing any IP messages from the client with a secure firewall application to insure such IP message are suitable for routing to the server application.

20. The method of claim 19 further including reconfiguring the secure firewall when the client is so authorized.

21. The method of claim 19 wherein the reconfiguring the secure firewall comprises obtaining a secure password from the client and temporarily modifying routing tables that are used to screen the exchanging the data.

22. The method of claim 19, wherein the IP connection is released as a result of receiving a disconnect IP message from the client and the IP address is released as a result of sending an address release IP message to the SSP.

23. The method of claim 19 wherein the IP connection is released as a result of receiving a disconnect IP message from the SSP by way of the wireless infrastructure and the IP address is released by the SSP after the disconnect IP message has been received.
